(19) United States
(12) Patent Application Publication
(10) Pub. No.: US 2013/0033510 A1
(43) Pub. Date: Feb. 7, 2013

(54) Techniques for Controlling Power Consumption of a System

(71) Applicants: Lingyun Dou, Beijing (CN); Yaodong Li, Beijing (CN)

(72) Inventors: Lingyun Dou, Beijing (CN); Yaodong Li, Beijing (CN)

(21) Appl. No.: 13/527,715

(22) Filed: Jun. 20, 2012

(30) Foreign Application Priority Data
Jun. 24, 2011 (CN) PCT/CN2011/001048

(51) Int. Cl. G09G 5/39

(52) U.S. Cl. 345/531

(57) ABSTRACT

A chipset can detect whether a relevant portion of the system frame buffer has been updated and can send an interrupt to the display driver to invoke a registered hardware watchpoint routine to inform display driver of the updating. If the display is currently in display self refresh (DSR) state, display driver wakes up display controller components and requests to transmit a MIPI compatible DCS command to request copying of the updated data from system frame buffer into an on-panel frame buffer or a frame buffer associated with the display. The display driver can power-down graphics system components and enter DSR state again to save power.

### FIELD

The subject matter disclosed herein relates generally to controlling power consumption of a system, and more particularly to controlling power used in connection with displaying images.

### RELATED ART

Display self-refresh (DSR) feature is used to reduce power consumption of a computer system. In DSR mode, a buffer accessible to a display is accessed and the image stored in the buffer is repeatedly displayed until the buffer is refreshed. In addition, in DSR mode, various hardware of the graphics subsystem that provide images to the buffer can be powered down. For example, in the graphics subsystem, a Display Serial Interface (DSI) Phase Locked Loop (PLL) can be powered-down and powered-gated to reduce power consumption. If the buffer is to be refreshed or updated, the graphics subsystem can re-enter normal power mode. In such case, the DSI PLL can be powered-up. Techniques are needed to decide when to power-up the graphics subsystem.

### BRIEF DESCRIPTION OF THE DRAWINGS

Embodiments of the present invention are illustrated by way of example, and not by way of limitation, in the drawings and in which like reference numerals refer to similar elements.

FIG. 1A depicts an example of a system that can use embodiments of the present invention.

FIG. 1B depicts an example of components of a host system whose power consumption can be controlled, in accordance with an embodiment.

FIG. 2 depicts an example of commands and data transfer operations that can take place.

FIG. 3 depicts an example process that can be used to determine when to power-on graphics components and update a panel buffer.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Applications or other logic can request to render image data into a system frame buffer. The image data can be used to display an image (e.g., still image or video) requested by the application. A chipset or other logic that is communicatively coupled to the system frame buffer can detect whether a particular portion of the system frame buffer is being updated. The chipset or other logic can send an interrupt to the display driver to invoke a registered hardware watch point routine to inform display driver of a change in the particular portion of the system frame buffer. In an embodiment, if the display (e.g., display controller and panel) is currently in display self refresh (DSR) state, a display driver requests to power-up components used to transfer image data to a display. The components can include display controller components such as a phase locked loop (PLL), display plane, and display pipe. At the same time or after requesting to power-up components, the display driver can request to transmit a command to request copying of updated particular portion of the system frame buffer into a frame buffer associated with the display. In some cases, a MIPI specification compatible DCS write memory command can be used to request copying of the updated data. The frame buffer associated with the display can be used for fetching of data for display of still images or video. When or after the data from the frame buffer associated with the display stores the entire updated portion, display driver can request to reduce power of the components (e.g., PLL, plane, and pipe) and enter DSR state again to save power. DSR state can be exited when there is any update to the system frame buffer or when a HwWatchpoint event occurs. When the display is in DSR state, the display can be refreshed using image data from the frame buffer associated with the display.

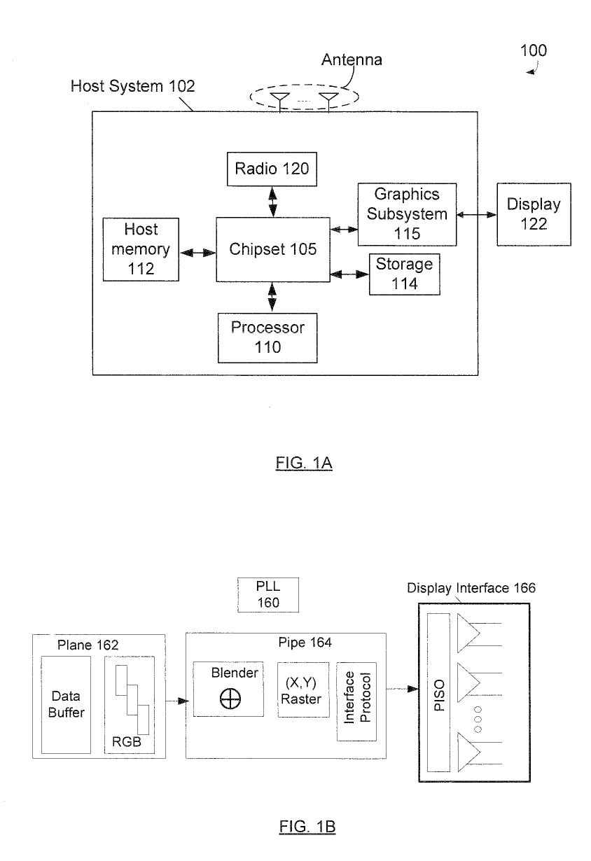

FIG. 1A depicts an example of a system that can use embodiments of the present invention. Computer system 100 may include host system 102 and display 122. Computer system 100 can be implemented in a handheld personal computer, tablet computer, mobile telephone, set top box, or any computing device. Host system 102 may include chipset 105, processor 110, host memory 112, storage 114, graphics subsystem 115, and radio 120. Chipset 105 may provide intercommunication among processor 110, host memory 112, storage 114, graphics subsystem 115, and radio 120. For example, chipset 105 may include a storage adapter (not depicted) capable of providing intercommunication with storage 114. In some implementations, chipset 105, processor 110, and graphics subsystem 115 can be implemented in a single system on chip (SoC).

Processor 110 may be implemented as Complex Instruction Set Computer (CISC) or Reduced Instruction Set Computer (RISC) processors, x86 instruction set compatible processors, multi-core, or any other microprocessor or central processing unit.

Host memory 112 may be implemented as a volatile memory device such as but not limited to a Random Access Memory (RAM), Dynamic Random Access Memory (DRAM), or Static RAM (SRAM). Storage 114 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device.

Graphics subsystem 115 may perform processing of images such as still images or video for display. An analog or digital interface may be used to communicatively couple graphics subsystem 115 and display 122. For example, the interface may be any of a High-Definition Multimedia Interface, DisplayPort, wireless HDMI, and/or wireless HD compliant techniques. Graphics subsystem 115 could be integrated into processor 110 or chipset 105. Graphics subsystem 115 could be a stand-alone card communicatively coupled to chipset 105.

Radio 120 may include one or more radios capable of transmitting and receiving signals in accordance with applicable wireless standards such as but not limited to any version of IEEE 802.11 and IEEE 802.16 as well 3GPP LTE advanced. For example, radio 120 may include at least a physical layer interface and media access controller.

FIG. 1B depicts an example of components of host system 102 whose power consumption can be controlled, in accordance with an embodiment. The components can be in chipset, processor, or graphics subsystem. For example, the display phase lock loop (PLL) 160, display plane 162, display pipe 164, and display interface 166 can be powered down or up. Powering down can include clock gating and/or power gating. Clock gating can include removing access to a clock source or reducing the frequency of the available clock source. Power gating can include removing connectivity to a power supply or reducing available power, voltage, or current. PLL 160 may provide a system clock for the display plane 162, display pipe 164, and/or display interface 166. For example, display plane 162 may include a data buffer and RGB color mapper, which transforms data from a buffer to RGB. Display plane 162 may include an associated memory controller and memory IO (not depicted) that could also be power managed by clock and/or power gating. Pipe 164 may include a blender of multiple layers of images into a composite image, as well as X, Y coordinate rasterizer, and interface protocol packetizer. The interface protocol packetizer may be compliant at least with any versions or variation of Display Port or Low-voltage differential signaling (LVDS), available from ANSI/TIA/EIA-644-A (2001). Display interface 166 may include a DisplayPort or LVDS compatible interface and a parallel-in-serial-out (PISO) interface.

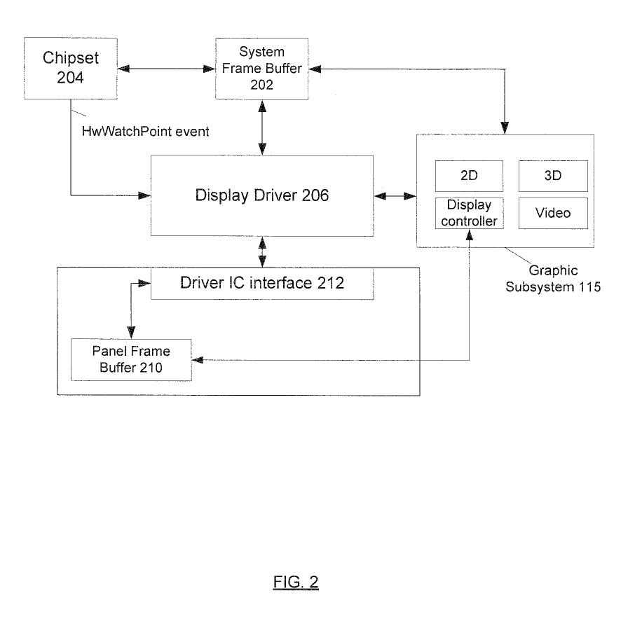

FIG. 2 depicts an example of commands and data transfer operations that can take place. The system of FIG. 2 can be MIPI Specification Type 1 Display Architecture, although other types of architecture are permitted such as to Type 2. MIPI Specification Type 1 Display Architecture permits use of a panel frame buffer to hold image data.

System frame buffer 202 can be any region of memory or storage, whether contiguous or distributed over memory addresses and/or lines. For example, a user space application can request to write updated display data into system frame buffer 202. The display data is to be displayed by a panel.

Chipset 204 can communicatively couple the processor (not depicted) to main memory (not depicted) and graphics controllers or sub-system and communicatively couple peripheral buses, such as PCI or ISA, for example. Chipset 204 can monitor updating or change of system frame buffer 202. Chipset 204 can issue a HwWatchPoint event interrupt to display driver 206 in the event of a change in content of system frame buffer 202. For example, an application can request a write to system frame buffer 202 to change an image that is to be displayed during DSR.

Various embodiments provide a hardware watchpoint similar to that of GNU debugger (gdb) to monitor a specific memory region. GNU debugger is used to monitor a memory region to aid diagnosis of memory corruption and generation of profile data.

Execution of routine drmModeAddFB( )(not depicted) can add a new system frame buffer 202 via specific system call. For example, X routine of Linux operating system can call routine drmModeAddFB( ). Calling routine drmModeAddFB( ) can also trigger the registration of the HwWatchpoint interrupt handling routine in display driver 206 so that the handling routine is known to be available in the event of an update to system frame buffer 202. The drmModeAddFB( ) routine can route to the kernel drm_mode_addfb( ) ioctl, which can call the display driver's callback routine fb_create( ). The fb_create( ) callback routine can establish the new frame buffer and trigger the registration of the interrupt handling routine.

If an operating system is used, hardware interrupts are directly handled by the OS first and the OS invokes a corresponding driver interrupt routine to handle a specific interrupt. Accordingly, registering the HwWatchpoint can involve the display driver registering its HwWatchpoint interrupt handler to the OS, so the OS will invoke this routine once it receives a HwWatchpoint event from chipset 204.

HwWatchpoint interrupt handling routine can be incorporated into display driver 206. HwWatchpoint interrupt handling routine can be available for use prior to registration of HwWatchpoint interrupt handling routine or adding a new system frame buffer.

In some cases, there is an existing monitored frame buffer when a new frame buffer is added. Accordingly, the watchpoint for the old frame buffer may be unregistered and a new watchpoint for the new frame buffer is registered. A hardware watchpoint exception handling routine can be called in response to a received watchpoint exception interrupt. Chipset 204 monitors updates to system frame buffer 202 and if an update occurs, chipset 204 sends a HwWatchPoint event and invokes the HwWatchPoint interrupt handler in display driver 206.

Display driver 206 can be responsible for the display panel entering or exiting DSR state. Display driver 206 can use a flag to track whether the display is in DSR state, such as an enter_dsr flag. In some embodiments, when DSR state is enabled, display driver 206 can register its HwWatchpoint interrupt handler with the OS or indicate handling routine is available in the event of an update to system frame buffer 202.

Display driver 206 monitors whether updating of system frame buffer 202 is complete or not complete. As long as the watchpoint exception interrupt indicates changes to system frame buffer 202, a hardware watchpoint exception handling routine used by display driver 206 causes the hardware elements used to transfer data to a memory used by a display to be in a power state to permit data transfer between system frame buffer and a panel frame buffer. For example, clock and/or power gating can be removed or alleviated. For example, the clock frequency can be increased. The hardware elements can include DSI PLL, display plane, and display pipe. Display driver 206 can issue a Display Command Set (DCS) command described in section 5.4 of the MIPI Alliance Specification for Display Command Set version 1.02 (2009) to request transfer of data from system frame buffer 202 to panel frame buffer 210. Driver IC interface 212 can receive the DCS command. Specifically, the write_memory_start command can be used. After the changes cease in system frame buffer 202, the hardware watchpoint exception handling routine does not indicate change in system frame buffer 202. Watchpoint can cease sending interrupts to display driver to indicate no more changes to system frame buffer. In response to the update ceasing, the hardware watchpoint exception handling routine can request to power gate and/or clock gate the hardware elements used to transfer data to a memory used by a display. For example, the clock frequency can be decreased.

Panel frame buffer 210 can be any region of memory, whether contiguous or distributed over memory addresses and/or lines. Panel frame buffer 210 can receive frame data from system frame buffer 202 through display controller via display plane or pipe. Display data can be transferred from system frame buffer 202 to panel frame buffer 210 using display controller of graphics subsystem 115. Display controller is capable of converting format of display data. Display controller can be compatible with a Display Bus Interface (DBI) v2.0 (2005), although other standards can be used. A display panel can access video or image data from panel frame buffer 210 for display. In DSR state, the screen on the panel can be refreshed using the same image from panel frame buffer 210.

Driver IC interface 212 can be a module in display panel that controls display and data transfer. Driver IC interface 212 can receive commands from display driver 206 at least to request writing to panel frame buffer 210. A write command (e.g., write_memory_start command) can inform driver IC interface 212 that data to be written is pixel data. Driver IC interface 212 can start to receive the pixel data and update the on-panel frame buffer with the received pixel data.

For some embodiments, the following pseudo-code can be used to register hardware watchpoint exception routine.

```
Portion A
    struct hwWatchpoint {
    void (*routine)(struct hwWatchpoint *, struct ptRegisters *);
    struct meminfoOfFramebufferRegion info;
        };
Portion B
    if (dsrIsEnabled( ))
    {
        if (newFramebufferRegion)
            unregisterHwWatchpoint(hwWatchpoint);
        acquireMemInfoOfCurrentFramebufferRegion(&memInfo);
        initHwWatchpoint(hwWatchpoint, meminfo);
        registerHwWatchPoint(hwWatchpoint);
    }
```

In portion A, “struct hwWatchpoint” includes member “routine( )” that specifies the hardware watchpoint exception handling routine, and member “info” indicates a specified frame buffer region.

In portion B, the pseudocode registers the routine HwWatchpoint when DSR is enabled. Command “If (newFramebufferRegion)” checks whether there is already a hwWatchpoint routine registered. If this is a new request to create a new system framebuffer, the pseudo code unregisters the older routine hwWatchpoint. Command “acquireMemInfoOfCurrentFramebufferRegion(&mem Info)” requests retrieval of the memory information for the current system frame buffer region. Command “initHwWatchpoint(hwWatchpoint, meminfo)” initializes the hwWatchpoint with the memory information of the current system frame buffer region. Command “registerHwWatchPoint(hwWatchpoint)” requests the registration for the hwWatchpoint.

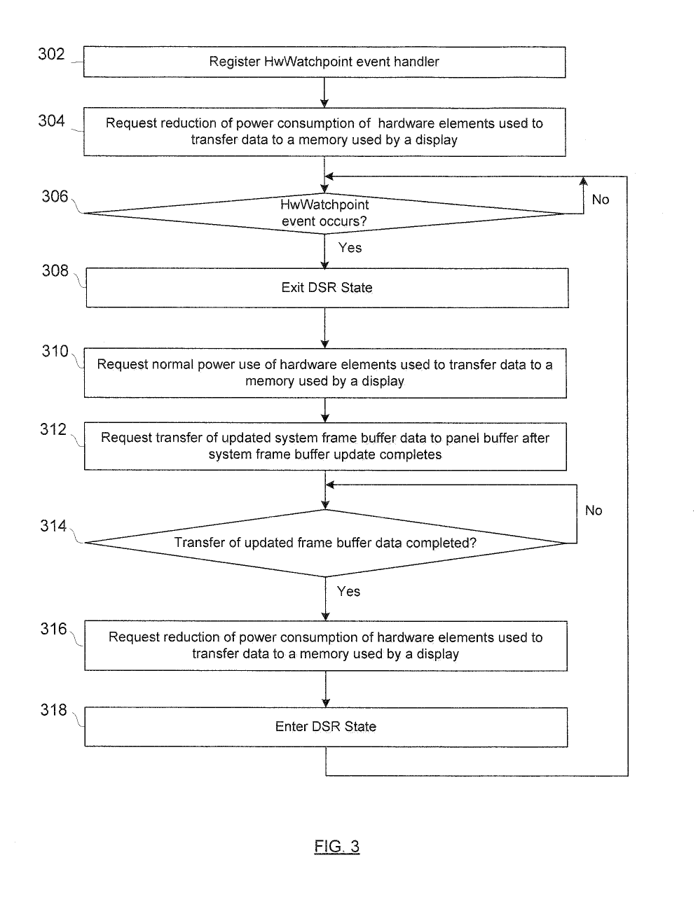

FIG. 3 depicts an example process that can be used to control power and clock usage of graphics components. The operations of FIG. 3 can be performed by a display driver.

Block 302 includes configuring a display driver to register HwWatchpoint event handler. An event handler can be registered at system boot time, when or after display driver loads, or in response to a system buffer change. Display driver 206 can register its HwWatchpoint interrupt handler with the OS or indicate handling routine is available in the event of an update to system frame buffer 202. After the HwWatchpoint event handler is registered successfully, the hwWatchpoint routine is able to power gate and/or clock gate the hardware elements used to transfer data.

Block 304 includes requesting reducing power consumption of hardware elements used to transfer data to a memory used by a display. The hardware elements can be used to transfer data from a system frame buffer to a display buffer. The hardware elements can include Display Serial Interface (DSI) Phase Locked Loop (PLL) as well as display controller plane and pipe. Reducing power consumption can include power gating and/or clock gating.

Block 306 includes determining whether a HwWatchpoint event has occurred. In some cases, a HwWatchpoint event is triggered by a write to a system frame buffer. For example, HwWatchpoint event can remain active during the beginning, middle, and/or end of writing to system frame buffer. If the HwWatchpoint event has occurred, block 308 follows block 306. If the HwWatchpoint event has not occurred, block 306 repeats.

A change to the system frame buffer can trigger exiting of DSR state (block 308). For example, receipt of HwWatchpoint event can trigger the display driver to exit DSR state.

Block 310 includes requesting normal power consumption of hardware elements used to transfer data to a memory used by a display. For example, the elements can be used to transfer data from a system frame buffer to a panel frame buffer. For example, block 310 can include increasing power consumption of DSI PLL and display controller plane and pipe. The display controller plane and pipe can be used to transmit updated system frame buffer data to the panel buffer. Increasing power consumption can include removing power and/or clock gating. Increasing power consumption can include setting the clock frequency to normal frequency or increasing the available clock frequency.

Block 312 includes requesting transfer of updated system frame buffer data to panel buffer after system frame buffer update completes.

Block 314 includes determining whether the transfer of updated frame buffer data to the panel buffer has completed. After completion, block 316 follows block 314.

Block 316 includes requesting reducing power consumption of hardware elements used to transfer data to a memory used by a display. Reducing power consumption can include power and/or clock gating. Powering down hardware elements used to transfer data to a memory used by a display can save more power of the whole system and improve the performance as well.

Block 318 includes requesting entering of DSR mode. In DSR mode, the updated contents of the panel frame buffer can be used to refresh images displayed on the panel.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multicore processor. In a further embodiment, the functions may be implemented in a consumer electronics device.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-implemented method comprising:
registering an event handler associated with writing of data to a first buffer;
recognizing an interrupt, wherein the interrupt indicates storage of data to the first buffer;
in response to the interrupt, requesting powering-up of elements used to transfer data to a second buffer and requesting transfer of data from the first buffer to the second buffer; and
in response to detecting completion of writing of data to the first buffer, requesting powering-down of the elements.

2. The method of claim 1, wherein the registering an event handler takes place in response to registration of the first buffer.

3. The method of claim 1, wherein the recognizing an interrupt comprises receiving an interrupt from a chipset communicatively coupled to the first buffer.

4. The method of claim 1, wherein the powering-up of elements comprises one of removing power gating and increasing clock frequency.

5. The method of claim 1, wherein the requesting transfer of data from the first buffer to the second buffer comprises issuing a MIPI specification write_memory_start command.

6. The method of claim 1, wherein the detecting completion of writing of data to the first buffer comprises not receiving any interrupt for a period of time.

7. The method of claim 1, wherein the requesting powering-down of the elements comprises requesting one of power gating of the elements and clock gating of the elements.

8. The method of claim 1, wherein the elements comprise one or more of a phase locked loop, display plane, and display pipe.

9. The method of claim 1, wherein the elements comprise a display controller.

10. A display driver executed by a computer system, the display driver configured to:
register an event handler, the event comprising a write to a first buffer;
in response to receipt of an interrupt indicating occurrence of the event, request powering-up of elements used to transfer data to a second buffer and request transfer of data from the first buffer to the second buffer; and
in response to an indication of completion of writing of data to the first buffer, request powering-down of the elements.

11. The display driver of claim 10, wherein the display driver is to register in response to addition of the first buffer.

12. The display driver of claim 10, wherein the interrupt comprises an interrupt from a chipset communicatively coupled to the first buffer.

13. The display driver of claim 10, wherein to request powering-up of elements comprises a request of one of removing power gating and increasing clock frequency.

14. The display driver of claim 10, wherein to request powering-down of the elements comprises a request of one of power gating of the elements and clock gating of the elements.

15. The display driver of claim 10, wherein the elements comprise one or more of a phase locked loop, display plane, and display pipe.

16. A system comprising:
a display;
a wireless network interface;
a first buffer;
a second buffer; and
a processor configured to:
register an event handler, the event comprising a write to a first buffer;
in response to receipt of an interrupt indicating occurrence of the event, request powering-up of elements used to transfer data to a second buffer and request transfer of data from the first buffer to the second buffer; and
in response to an indication of completion of writing of data to the first buffer, request powering-down of the elements.

17. The system of claim 16, wherein the processor is to register in response availability of the first buffer.

18. The system of claim 16, wherein to request powering-up of elements comprises a request of one of removing power gating and increasing clock frequency.

19. The system of claim 16, wherein to request powering-down of the elements comprises a request of one of power gating of the elements and clock gating of the elements.

20. The system of claim 16, wherein the elements comprise one or more of a phase locked loop, display plane, and display pipe.
